(19) United States
(12) Patent Application Publication
(10) Pub. No.: US 2024/0212439 A1
(43) Pub. Date: Jun. 27, 2024

(54) Bet Placement

(71) Applicant: DK Crown Holdings Inc., Boston, MA (US)

(72) Inventors: John Creaner, Dublin (IE); Ozan Gursoy, Dublin (IE); Dhruv Ishpuniani, Dublin (IE); Victor Masutani, Dublin (IE); Oleg Gelman, Sofia (BG)

(73) Assignee: DK Crown Holdings Inc., Boston, MA (US)

(21) Appl. No.: 18/087,507

(22) Filed: Dec. 22, 2022

(51) Int. Cl. G07F 17/32

(52) U.S. Cl. CPC G07F 17/323; G07F 17/3288

(57) ABSTRACT

Systems and processes for bet processing system for independent and/or live on-line gaming are disclosed. For an implementation, a system may include a front-end system (FES) that includes at least one FES server performs first front-end operations including communicating a betting option for an event to a user device, receiving a bet, from the user device, for the event, monitoring the event, and validating the bet. The system may include a back-end system (“BES”) coupled to the FES, which includes at least one BES server configured receive the bet from the FES, verify the user, validating user funds and designate, from the user funds, reserved funds for covering the bet. The front-end operations are performed independently of the back-end operations. The FES may include a wager server communicating the betting option to the user device and receiving the bet, and a gaming server monitoring the event and validating the bet.

### CROSS-REFERENCE TO RELATED APPLICATION

This application is related to U.S. patent application Ser. No. 18/087,371, which was co-filed herewith on 22 Dec. 2022, in the name of inventors Mark Lysaght, Ozan Gursoy, Dhruv Ishpuniani, and Victor Masutani, entitled “Message Driven Gaming Systems and Processes” and which is further identified by the Attorney Docket Number DKPHP2022-09-01 (DK-00003), the entire contents of which are incorporated herein by reference.

### TECHNICAL FIELD

The technology described herein generally relates to devices, systems, and processes for communicating data packets between front-end server and back-end servers utilized to facilitate on-line gaming.

### BACKGROUND

Online gaming systems commonly utilize a combination of one or more front-end servers and one or more back-end servers. The front-end servers commonly facilitate betting on one or more “events.” As used herein, an “event” (which is also referred to as a “gaming event”) is an occurrence upon which a bet may be placed. Non-limiting examples of “events” include sporting contests, political campaigns, social media events, and the like. The front-end server(s) commonly identify an event (e.g., a sporting game or otherwise) with respect to which bets are being accepted, generate odds for the event, track the event as it progresses, receive bets, confirm bet placement, resolve bets (e.g., determine whether an event result is consistent with, contrary to, or otherwise with respect to a given one or more bet(s)), communicate bet settlement results to users, and the like. Multiple front-end servers may be coupled for large events, such as the SUPER BOWL. The back-end servers commonly facilitate accounting, compliance, user verification, and similar function. Multiple back-end servers may be coupled together.

The front-end servers and back-end servers are communicatively coupled using networks, such as the Internet and others. Such communications are often accomplished using the hyper-text transfer protocol (HTTP), whereby a data packet is pushed to a receiving server and an acknowledgement receipt message thereof is returned. The acknowledgement receipt verifying successful transmission of the data packet to the receiving server. If the acknowledgement receipt message is not received within a given time period, the data packet will typically be retransmitted. When the networks, servers or other system components become inoperable, saturated, deteriorated, or otherwise operate in a limited and/or reduced capacity, the sending and receiving of a data packet and an acknowledgement receipt message may be delayed, dropped, or otherwise non-timely communicated. These disruptions may result in one or more of the back-end systems and front-end systems having to resend one or more such data packets or acknowledgement receipts, and result in further network congestion and/or utilization of system processing resources—often resulting in an increase in both the quantity of messages communicated and the order/sequencing in which two or more data packets are communicated. These delays and non-sequential processing of data packets also often result in further processing and communications delays by front-end and back-end servers. Given the time-sensitive and sequence sensitive nature of the data packets communicated for on-line gaming systems current approaches are inefficient. Accordingly, a need exists for systems and processes for on-line gaming systems which address these and other needs.

### SUMMARY

Various implementations are described of devices, systems and processes for on-line gaming of independent bets and live bets.

In accordance with at least one implementation of the present disclosure a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

For at least one implementation, a first system may include a front-end system (FES). The FES includes at least one FES server configured to execute computer instructions which configure the FES to perform first front-end operations that may include:

communicating a betting option for an event to a user device; where the user device is associated with a user; receiving a bet, from the user device, for the event; monitoring the event; and validating the bet. The first system may include a back-end system (BES) coupled to the FES. The BES includes at least one BES server configured to second computer instructions which configured the BES to perform first back-end operations that may include: receiving the bet from the FES; verifying the user; validating user funds; and designating, from the user funds, reserved funds for covering the bet. The front-end operations are performed independently of the back-end operations. Other implementations may include corresponding computer systems, apparatus, and computer programs recorded on one or more computer storage devices, each configured to perform one or more of the computer instructions.

For at least one implementation of the first system, the at least one FES server may include: a wager server, coupled to the user device. The BES may include a wager server processor and a wager data store, coupled to wager server processor and non-transiently storing wager computer instructions. The BES may include a gaming server, coupled to the wager server and the BES, which includes: a gaming server processor and a gaming data store, coupled to the gaming server processor, non-transiently storing gaming computer instructions.

For at least one implementation of the first system, the wager computer instructions, when executed by the wager server processor, instruct the FES to perform the first front-end operations of communicating, in a second message, the betting option for the event to the user device associated with the user. The operations may also include receiving the bet, from the user device, for the event. The operations may further include performing second front-end operations including: receiving the betting option from the gaming server; receiving the bet in a bet placement message (BPM) sent by the user device; communicating the BPM to the gaming server; and communicating the BPM to the BES.

For at least one implementation of the first system, the gaming computer instructions, when executed by the gaming server processor, further instruct the FES to perform the first front-end operations of monitoring the event and validating the bet, and to further perform third front-end operations including identifying the event, generating the odds for the event, generating the betting option, and communicating the betting option in a first message to the wager server. The first message may identify the event and the odds for the event. The operations may further include receiving the BPM from the wager server, receiving a placed bet message (PBM) from the BES, validating the event, and monitoring the event. When the event ends, the operations may further include generating an updated placed bet message (UPBM), communicating the UPBM to the wager server, and communicating the UPBM to the BES.

For at least one implementation of the first system, the event may be an on-line gaming event.

For at least one implementation of the first system, the gaming computer instructions further may instruct the FES to periodically generate the UPBM during the event. The UPBM may include an event status.

For at least one implementation of the first system, the gaming computer instructions, when executed by the gaming server processor, may instruct the FES to perform the first front-end operations of monitoring the event and validating the bet. Additional second front-end operations may include identifying the event, generating the odds for the event, generating the betting option, and communicating the betting option in a first message to the wager server. The first message may identify the event and the odds for the event. Operations may further include receiving the BPM from the wager server, receiving a placed bet message (PBM) from the BES, validating the event, and monitoring the event. When the event ends, the operations may include generating an updated placed bet message (UPBM), communicating the UPBM to the wager server, and communicating the UPBM to the BES.

For at least one implementation of the first system, the PBM may include a bet reserve identifier (BRID) associated with the BPM.

For at least one implementation of the first system, at least one BES server may include: a bet processing server, coupled to the FES, which may include: a bet processing server processor; and a bet processing data store, coupled to bet processing server processor, and nontransiently storing bet processing computer instructions. The BES may include a user verification server, coupled to the bet processing server, which may include: a user verification server processor, and a user verification data store, coupled to the user verification server processor, nontransiently storing user verification computer instructions. The BES may include an accounting server, coupled to the processing server, which may include: an accounting server processor, and an accounting data store, coupled to the accounting server processor, nontransiently storing accounting computer instructions.

For at least one implementation of the first system, the bet processing computer instructions, when executed by the bet processing server processor, instruct the BES to perform the first back-end operations of receiving the bet from the FES, and designating, from the user funds, reserved funds for covering the bet. Second back-end operations may be performed and include: receiving, from the wager server, a bet placement message (BPM). The operations may include further designating the reserved funds, by further performing operations including sending, based on data provided in the BPM, a funds validation request to the accounting server, and receiving, from the accounting server in response to the funds validation request, a user funds confirmation message when sufficient user funds exist in at least one account associated with the user for the reserved funds. The operations may include communicating first user data provided in the BPM to the user verification server, communicating second user data provided in the BPM to the accounting server; associating a best reserve identifier (BRID) with the BPM, communicating a placed bet message (PBM) to the gaming server, and upon, receiving an updated placed bet message (UPBM) from the gaming server indicating that the event has completed, performing debit verification and releasing, after debit verification has completed, any remaining reserved funds back into the user account.

For at least one implementation of the first system, the user verification computer instructions, when executed by the user verification server processor, may instruct the BES to perform the first back-end operation of verifying the user based on first user data provided in a BPM received from the bet processing server, and the accounting computer instructions, when executed by the accounting server processor, may instruct the BES to perform the first back-end operation of validating user funds based on second user data provided in a BPM received from the bet processing server.

For at least one implementation of the first system, the first user data may include a user identifier, an operation identifier, an amount, a client key, user account information, and a bet identifier. The second user data may include the user identifier, the amount identifier, a purchase identifier, the user account information, the bet identifier and the BRID.

For at least one implementation of the first system, the user verification computer instructions, when executed by the user verification server processor, instruct the BES to: perform the first back-end operation of verifying the user based on first user data provided in a BPM received from the bet processing server. The accounting computer instructions, when executed by the accounting server processor, instruct the BES to perform the first back-end operation of validating user funds based on second user data provided in a BPM received from the bet processing server. Implementations of the described techniques may include hardware, a method or process, or computer software on a computer-accessible medium.

For at least one implementation, a second system may include: a user device associated with a user; a front-end system (FES) coupled to the user device; and a back-end system (BES) coupled to the FES. The FES may include: a wager server that may include: a wager server processor and a wager data store, coupled to wager server processor, non-transiently storing wager computer instructions; and a gaming server may include: a gaming server processor; and a gaming data store, coupled to the gaming server processor, non-transiently storing gaming computer instructions. The wager computer instructions, when executed by the wager server processor, instruct the FES to perform first front-end operations including: receiving a betting option for an event from a gaming server; communicating the betting option to the user device; receiving a bet placement message (BPM) from the user device; where the BPM identifies a bet, by the user, for the event; communicating the BPM to the gaming server; and communicating the BPM to the BES. The gaming computer instructions, when executed by the gaming server processor, instruct the FES to perform second front-end operations including: identifying the event; generating odds for the event; generating the betting option; communicating the betting option to the wager server; where the betting option identifies the event and the odds for the event; receiving the BPM from the wager server; validating the bet; receiving a placed bet message (PBM) from the BES; validating the event; monitoring the event; generating an updated placed bet message (UPBM) when the event ends; communicating the UPBM to the wager server; and communicating the UPBM to the BES. The BES may include: a bet processing server that may include a bet processing server processor and a bet processing data store, coupled to bet processing server processor, nontransiently storing bet processing computer instructions; a user verification server may include a user verification server processor and a user verification data store, coupled to the user verification server processor, nontransiently storing user verification computer instructions; and an accounting server may include an accounting server processor and an accounting data store, coupled to the accounting server processor, nontransiently storing accounting computer instructions.

The bet processing computer instructions, when executed by the bet processing server processor, instruct the BES to perform first back-end operations including receiving, from the wager server, the BPM, communicating first user data provided in the BPM to the user verification server, communicating second user data provided in the BPM to the accounting server, sending a funds validation request to the accounting server, when sufficient user funds exist in a user account to cover the bet, receiving, from the accounting server in response to the funds validation request, a user funds confirmation message designating identified user funds, designating the identified user funds as reserved funds for the bet, associating a best reserve identifier (BRID) with the BPM, communicating a placed bet message (PBM) to the gaming server, and upon, receiving the UPBM from the gaming server indicating that the event has completed, performing debit verification, and releasing, after debit verification has completed, any remaining reserved funds back into the user account.

The user verification computer instructions, when executed by the user verification server processor, instruct the BES to verify the user based on first user data provided in the BPM. The accounting computer instructions, when executed by the accounting server processor, instruct the BES to validate user funds based on second user data provided in the BPM. Other implementations may include corresponding computer systems, apparatus, and computer programs recorded on one or more computer storage devices, each configured to perform one or more of the operations.

For at least one implementation of the second system, the gaming computer instructions further instruct the FES to periodically generate the UPBM during the event. The UPBM may include an event status. For at least one implementation of the second system, the gaming computer instruction, upon validating the event, may further instruct the FES to communicate a validated placed bet message (VPBM) to the user device and the VPBM may indicate that the bet will occur unless timely cancelled by the user. Implementations of the described techniques may include hardware, a method or process, or computer software on a computer-accessible medium.

For at least one implementation a process for processing live bets for an event, may include: communicating, by a user device, a live bet message to a front-end system (FES) of a bet processing system. The live bet message identifies, for a bet, a user, an amount, a user account, and an event. The process may further include allocating, by the FES and as currently reserved funds, previously reserved user funds for live betting in the user account, validating the event, communicating a bet conditions message (BCM) by the FES to the user device, monitoring the event, updating the BCM based upon a current event status and generating an updated bet conditions message (UBCM). The operations may further include communicating at least one UBCM to a back-end system (BES), tracking, by the BES and in view of the at least one UBCM, a status of the currently reserved funds, converting, by the BES, at least a portion of the previously reserved funds into a debit to the user account when the current event status indicates the event is completed, and communicating, when the event is completed, by the FES and to the user device, a bet finished message indicates whether one or more credits or debits have been applied to the user account in view of the bet and results of the event. Other implementations may include corresponding computer systems, apparatus, and computer programs recorded on one or more computer storage devices, each configured to perform the actions of the process.

For at least one implementation of the process, the BCM may include a reserve identifier which designates a common reserve identifier to be used by the FES for live betting. Implementations of the described techniques may include hardware, a method or process, or computer software on a computer-accessible medium.

### BRIEF DESCRIPTION OF THE DRAWINGS

The features, aspects, advantages, functions, modules, and components of the devices, systems and processes provided by the various implementations of implementations of the present disclosure are further disclosed herein regarding at least one of the following descriptions and accompanying drawing figures. In the appended figures, similar components or elements of the same type may have the same reference number and may include an additional alphabetic designator, such as 108a-108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When the first reference label is used in the specification, the description is applicable to any of the similar components and/or views having the same first reference number irrespective of any additional alphabetic designators or second reference labels, if any.

FIG. 1 is a schematic illustration of a bet processing system for independent and/or live on-line gaming and in accordance with at least one implementation of the present disclosure.

FIG. 2 is a schematic for a server and in accordance with at least one implementation of the present disclosure.

FIG. 3 illustrates a sequence of communications utilized in a process for placing a bet and in accordance with at least one implementation of the present disclosure.

FIG. 4 illustrates data fields used in a bet placement message (BPM) communicated from a user device to a first front end server and in accordance with at least one implementation of the present disclosure.

FIGS. 5A and 5B illustrate data fields used in a placed bet message (PBM) that has been assigned a reserve ID by a back end server and in accordance with at least one implementation of the present disclosure.

FIG. 6 illustrates data fields used in a validated placed bet message (VPBM) message and in accordance with at least one implementation of the present disclosure.

FIG. 7 illustrates data fields used in an updated placed bet message (UPBM) and in accordance with at least one implementation of the present disclosure.

FIG. 8 is a timing chart illustrating one process for live bet processing and in accordance with at least one implementation of the present disclosure.

### DETAILED DESCRIPTION

Various implementations of the present disclosure describe independent bet processing devices, systems, and processes for on-line gaming.

“Additional I/O interface” (AIOI) herein refers to one or more components, provided with or coupled to a device, configured to support a receiving and/or presenting of additional inputs and outputs to and from one or more users. An AIOI may be configured to support the receiving and presenting of the additional I/O content (AIO) to users. Herein, the AIO, as communicated, may be referred to as “AIO signals”). An AIO signal may not include an audible signal or a visible signal but may be communicated separately or collectively therewith. An AIOI may include any interface not otherwise categorized as an Audio I/O interface or a Visual I/O interface with non-limiting examples including touch pads, keyboards, sensors, motion detectors, tactile elements, and the like. Any known or later arising technologies configured to convey information to or from one or more users as an AIO signal may be utilized for at least one implementation of the present disclosure. An AIOI generally includes hardware and computer instructions (herein, “AIO technologies”) which supports the input and output of other signals with a user.

“Application” herein refers to a set of computer instructions that configure one or more processors perform one or more tasks that are other than tasks commonly associated with the operation of the processor itself (e.g., a “system software,” an example being an operating system software), or the providing one or more utilities provided by a device (e.g., a “utility software,” an example being a print utility). An application may be bundled with a given device or published separately. Non-limiting examples of applications include word processing applications (e.g., Microsoft WORD™), video streaming applications (e.g., SLINGTV™), video conferencing applications (e.g., ZOOM™), gaming applications (e.g., FORTNITE™), and the like.

“Audio I/O interface” herein refers to one or more components, provided with or coupled to an electronic device, configured to support a receiving and/or presenting of humanly perceptible audible content to one or more users. Such audible content (which is also referred to herein as being “audible signals”) may include spoken text, sounds, or any other audible information. Such audible signals may include one or more humanly perceptible audio signals, where humanly perceptible audio signals typically arise between 20 Hz and 20 KHz. The range of humanly perceptible audio signals may be configurable to support an audible range of a given individual user. An audio I/O interface generally includes hardware and computer instructions (herein, “audio technologies”) which supports the input and output of audible signals to a user. Such audio technologies may include, but are not limited to, noise cancelling, noise reduction, technologies for converting human speech to text, text to speech, translation from a first language to one or more second languages, playback rate adjustment, playback frequency adjustment, volume adjustments and otherwise. An audio I/O interface may use one or more microphones and speakers to capture and present audible signals respectively from and to a user. Such one or more microphones and speakers may be provided by a given device itself or by a device communicatively couple additional audible device component. For example, earbuds may be communicatively coupled to a smartphone, with the earbuds functioning as an audio I/O interface and capturing and presenting audio signals as sound waves to and from a user, while the smartphone functions as a UD. An audio I/O interface may be configured to automatically recognize and capture comments spoken by a user and intended as audible signals for sharing with other users, inputting commands, or otherwise.

“Back-end system” (BES) herein refers to one or more computer servers, data storage devices, applications, and the like which, singularly and/or cooperatively, address one or more back-end on-line gaming functions. As used herein, a “back-end online gaming function” (BEOGF) is one or more data processing operations and communications operations performed by one or more servers which facilitate one or more of user verification, regulatory compliance, accounting, and the like. A back-end system may include one or more servers, data stores, communications interfaces, user interfaces, security, power, busses, and related components. The back-end system components may be physically, logically, virtually or otherwise grouped and/or coupled to facilitate the one or more back-end online gaming functions including, but not limited to, those identified herein.

“Bus” herein refers to any known and/or later arising technologies which facilitate the transfer of data within and/or between devices. Non-limiting examples include Universal Serial Bus (USB), PCI-Express, Compute Express Link (CXL), IEEE-488 bus, High Performance Parallel Interface (HIPPI), and the like.

“Cloud” herein refers to cloud computing, cloud storage, cloud communications, and/or other technology resources which a given user does not actively manage or provide. A usage of a Cloud resource may be private (limited to various users and/or uses), public (available for many users and/or uses), hybrid, dedicated, non-dedicated, or otherwise. It is to be appreciated that implementations of the present disclosure may use Cloud resources to provide for processing, storage and other functions related to facilitating bet settlement. An implementation may utilize Cloud resources using any known or later arising data delivery, processing, storage, virtualization, or otherwise technologies, standards, protocols (e.g., the Simple Object Access Protocol (SOAP), the Hyper Text Transfer Protocol (HTTP), Representational State Transfer protocol (REST), the KAFKA protocol, as provided by the Apache Software Foundation and as further described at https://kafka.apache.org/documentation/#introduction (the contents of which are incorporated herein by reference), or the like. Non-limiting examples of such technologies include Software as a Service (SaaS), Platform as a Service (Paas), Infrastructure as a Service (Iaas), and the like. Cloud resources may be provided by one or more entities, such as AMAZON WEB SERVICES provided by Amazom.com Inc., AZURE provided by Microsoft Corp., and others.

“Computer engine” (or “engine”) herein refers to a combination of a processor and computer instruction(s). A computer engine executes computer instructions to perform one or more logical operations (herein, a “logic”) which facilitate various actual (non-logical) and tangible features and function provided by a system, a device, and/or combinations thereof.

“Content” herein refers to data that that may be presented, using a suitable presentation device, to a user in a humanly perceptible format. When presented to a human, the data becomes “information.” Non-limiting examples of content include gaming images and graphics such as those related to bet placement, or otherwise. Content may include, for example and not by limitation, one or more sounds, images, video, graphics, gestures, or otherwise. The content may originate from any source, including live and/or recorded, augmented reality, virtual reality, computer generated, or otherwise. The content may be presented to a given user using any user device and any user interface. Content may be stored, processed, communicated, or otherwise utilized.

“Coupling” herein refers to the establishment of a communications link between two or more elements of a given system. A coupling may utilize any known and/or later arising communications and/or networking technologies, standards, protocols or otherwise. Non-limiting examples of such technologies include packet switch and circuit switched communications technologies, with non-limiting examples including, Wide Area Networks (WAN), such as the Internet, Local Area Networks (LAN), Public Switched Telephone Networks (PSTN), Plain Old Telephone Service (POTS), cellular communications networks such as a 3G/4G/5G or other cellular network, IoT networks, Cloud based networks, private networks, public networks, or otherwise. One or more communications and networking standards and/or protocols may be used, with non-limiting examples including, the TCP/IP suite of protocols, ATM (Asynchronous Transfer Mode), the Extensible Message and Presence Protocol (XMPP), VOIP, Ethernet, Wi-Fi, CDMA, Z-WAVE, Near Field Communications (NFC), GSM/GRPS, TDMA/EDGE, EV/DO, WiMAX, SDR, LTE, MPEG, BLUETOOTH, and others. A coupling may include use of physical data processing and communication components. A coupling may be physically and/or virtually instantiated. Non-limiting examples of physical network components include data processing and communications components including computer servers, blade servers, switches, routers, encryption components, decryption components, and other data security components, data storage and warehousing components, and otherwise. Any known or later arising physical and/or virtual data processing and/or communications components may be utilized for a given coupling.

“Data” (which is also referred to herein as a “computer data”) herein refers to any representation of facts, information or concepts in a form suitable for processing, storage or the like by one or more electronic device processors, data stores or the like. Data, while and/or upon being processed, may cause or result in an electronic device or other device to perform at least one function, task, operation, provide a result, or otherwise. Data may be communicated, processed, stored and/or otherwise exist in a transient and/or non-transient form, as determined by any given state of such data, at any given time. For a non-limiting example, a given data packet may be non-transient while stored in a storage device, but transient during communication of the given data packet from a first device or system to a second (or more) device or system. When received and stored in memory, data storage device, or otherwise, the given data packet may again have a non-transient state. For example, and not by limitation, data may take any form including as one or more applications, content, or otherwise.

“Data store” herein refers to any device or combinations of devices configured to store data on a temporary, permanent, transient, non-transient, or other basis. A data store may store data in any form, such as electrically, magnetically, physically, or otherwise. A data store may include a memory devices, with non-limiting examples including random access memory (RAM) and read only memory (ROM) devices. A data store may include one more storage devices, with non-limiting examples including electrical storage drives such as EEPROMs, Flash drives, Compact Flash (CF), Secure Digital (SD) cards, Universal Serial Bus (USB) cards, and solid-state drives, optical storage drives such as DVDs and CDs, magnetic storage drives such as hard drive discs, magnetic drives, magnetic tapes, memory cards, and others. Any known or later arising memory and data storage device technologies may be utilized for a given data store. Available storage provided by a given one or more data stores may be partitioned or otherwise designated by the storage controller as providing for permanent storage and temporary storage. Non-transient data, computer instructions, or other the like may be suitably stored in a data store. As used herein, permanent storage is distinguished from temporary storage, with the latter providing a location for temporarily storing data, variables, or other instructions used for a then arising data processing operations. A non-limiting example of a temporary storage is a memory component provided with and/or embedded onto a processor or integrated circuit provided therewith for use in performing then arising data calculations and operations. Accordingly, it is to be appreciated that a reference herein to “temporary storage” is not to be interpreted as being a reference to transient storage of data. Permanent storage and/or temporary storage may be used to store transient and non-transient data and content.

For at least one implementation, an “acceptable delay” is a delay of less than a given metric, for example and not by limitation, four seconds (4 s) under normal load conditions and thirty seconds (30 s) under heavy load conditions. For example, a delay between an outputting of a given bet settlement data packet by a back-end system element and a receipt of the given bet settlement data packet by a client centric system element may be an acceptable delay if less than four seconds (4 s) during a normal load condition, e.g., during a weekly PREMIER LEAGUE™ football match, a U.S. NFL™ game or the like, while a delay of thirty seconds (30 s) may be an acceptable delay under heavy load conditions, e.g., during a SUPER BOWL™ game, the WORLD CUP™ finals, or the like. Accordingly, it is to be appreciated that an acceptable delay may vary based on current system load conditions.

For at least one implementation, an “acceptable delay” is a delay of less than a given metric, for example and not by limitation, twenty seconds (20 s). For example, a delay of less than twenty seconds (20 s) between an outputting of a given bet settlement data packet by a back-end system element and a receipt of the given bet settlement data packet by a client centric system element may be an acceptable delay.

For at least one implementation, a given delay may be determined based on a quantification of one or more networked communications characteristics occurring between a back-end system element and a front-end system element. It is to be appreciated that such one or more networked communications characteristics may vary over time and with use thereof.

“Device” and “electronic device” herein refer to any known or later arising electrical device configured to, singularly and/or in combination, communicate, manipulate, output for presentation as information to a human, process, store, or otherwise utilize data. Non-limiting examples of devices include user devices and servers.

“Front-end system” (FES) herein refers to one or more user devices, servers, data storage, communications interfaces, and related components which, singularly and/or cooperatively, address one or more front-end on-line gaming functions. As used herein, a “front-end online gaming function” (FEOGF) is one or more data processing and/or communications operations performed by one or more user devices and/or servers which facilitate one or more of event identification, odds making, bet placement, event tracking, event settlement, and the like. A front-end system may include one or more user devices, servers, data stores, communications interfaces, user interfaces, busses, and related components. The front-end system components may be physically, logically, virtually or otherwise grouped and/or coupled to facilitate the one or more front-end online gaming functions including, but not limited to, those identified herein.

“Instruction” (which is also referred to herein as a “computer instruction”) herein refers to a non-transient processor executable instruction, associated data structure, sequence of operations, program modules, or the like. An instruction is described by an instruction set. It is commonly appreciated that instruction sets are often processor specific and accordingly an instruction may be executed by a processor in an assembly language or machine language format that is translated from a higher level programming language. An instruction may be provided using any form of known or later arising programming; non-limiting examples including declarative programming, imperative programming, functional programming, procedural programming, stack based programming, object-oriented programming, and otherwise. An instruction may be performed by using data and/or content stored in a data store on a transient and/or non-transient basis, as may arise for any given data, content and/or instruction.

“Live” herein when used to refer to on-line gaming, refers to a bet placement that occurs during a given event and before a given event activity occurs. A non-limiting example of a “live” bet is a bet placed during an NFL™ football game and before a given event activity occurs. For a non-limiting example, a live bet is a bet placed after an expiration of a regular time period for the football game (the event) where the bet chooses a result (the event activity) of an upcoming coin-toss (e.g., “heads” or “tails”)—the coin toss determining who gets the option to receive a kick-off of the football during an overtime period. By comparison, a non-limiting example of a non-live bet (herein, also referred to as an “independent bet”), is a bet placed before the football game (the game=the event) begins as to the ultimate winner thereof (the winner=the event activity).

“Module” herein refers to and, when claimed, recites definite structure for an electrical/electronic device that is configured to provide at least one feature and/or output signal and/or perform at least one function including the features, output signals and functions described herein. Such a module may provide the one or more functions using computer engines, processors, computer instructions and the like. When a feature, output signal and/or function is provided, in whole or in part, using a processor, one more software components may be used and a given module may include a processor configured to execute computer instructions. A person of ordinary skill in the art (a “POSITA”) will appreciate that the specific hardware and/or computer instructions used for a given implementation will depend upon the functions to be accomplished by a given module. Likewise, a POSITA will appreciate that such computer instructions may be provided in firmware, as embedded software, provided in a remote and/or local data store, accessed from other sources on an as-needed basis, or otherwise. Any known or later arising technologies may be used to provide a given module and the features and functions supported therein.

“Power Supply/Power” herein refers to any known or later arising technologies which facilitate the use of electrical energy by a device. Non-limiting examples of such technologies include batteries, power converters, inductive charging components, line-power components, solar power components, and otherwise.

“Processor” herein refers to one or more known or later developed hardware processors and/or processor systems configured to execute one or more computer instructions, with respect to one or more instances of computer data, and perform one or more logical operations. The computer instructions may include instructions for executing one or more applications, software engines, and/or processes configured to perform computer executable operations. Such hardware and computer instructions may arise in any computing configuration including, but not limited to, local, remote, distributed, blade, virtual, or other configurations and/or system configurations. Non-limiting examples of processors include discrete analog and/or digital components that are integrated on a printed circuit board, as a system on a chip (SOC), or otherwise; Application specific integrated circuits (ASICs); field programmable gate array (FPGA) devices; digital signal processors; general purpose processors such as 32-bit and 64-bit central processing units; multi-core ARM based processors; microprocessors, microcontrollers; and the like. Processors may be implemented in single or parallel or other implementation structures, including distributed, Cloud based, and otherwise.

“Real-time” herein refers to a presentation of information to a human that occurs substantially simultaneously with a resolution of an event, such as an activity with respect to which a bet has been placed.

“Security Component/Security” herein refers to any known or later arising processor, computer instruction, and/or combination thereof configured to secure data as communicated, processed, stored, or otherwise manipulated. Non-limiting examples of security components include those implement encryption standards, such as an Advanced Encryption Standard (AES), transport security standards, such as Transport Layer Security (TLS) or Secure Sockets Layer (SSL).

“Server” herein refers to one or more devices that include computer hardware and/or computer instructions that provide functionality to one or more other programs or devices (collectively, “clients”). Non-limiting examples of servers include database servers, file servers, application servers, web servers, communications servers, virtual servers, computing servers, and the like. Servers may be combined into clusters (e.g., a server farm), logically or geographically grouped, or otherwise. Any known or later arising technologies may be used for a server.

A server may instantiate one or more computer engines as one or more threads operating on a computing system having a multiple threaded operating system, such as the WINDOWS 10 operating system, LINUX, APPLE OS, ANDROID, and others, as an application program on a given device, as a web service, or otherwise. An Application Program Interface (API) may be used to support an implementation of the present disclosure. A server may be provided in the virtual domain and/or in the physical domain. A server may be associated with a human user, a machine process executing on one or more computing devices, an API, a web service, instantiated on the Cloud, distributed across multiple computing devices, or otherwise. A server may be any electronic device configurable to communicate data using a network, directly or indirectly, to another device, to another server, or otherwise.

“Substantially simultaneous(ly)” herein refers to an absence of a greater than expected and humanly perceptible delay between a first event or condition, such as a completion of a gaming activity, and a second event or condition, such as a presentation of a bet settlement for a bet placed with respect to the gaming activity. Substantial simultaneity may vary in a range of quickest to slowest expected delay, to a moderate delay, or to a longer delay. For at least one implementation, substantial simultaneity occurs within an acceptable delay (as described above).

“User Device” herein refers to a device configured for use by a human being to one or more of communicate, present, process, and store data. Non-limiting examples of user devices include smartphones, laptop computers, tablet computing devices, desktop computers, smart televisions, smart glasses, virtual reality glasses, augmented reality glasses, earbuds/headphones and other audible output devices, and other devices.

“User Interface” herein refers to one more components, provided with or coupled to a device configured to receive information from and/or present information to a user. A user interface may include one more Additional I/O interfaces, Audio I/O interfaces, and Visual I/O interfaces.

“Visual I/O interface” herein refers to one or more components, provided with or coupled to a device, configured to support a receiving and/or presenting of humanly perceptible visual content to one or more users. A visual I/O interface may be configured to support the receiving and presenting of visual content (which is also referred to herein as being “visible signals”) to users. Such visible signals may be in any form, such as still images, motion images, augmented reality images, virtual reality images, and otherwise. A visual I/O interface generally includes hardware and computer instructions (herein, “visible technologies”) which supports the input by and output of visible signals to users via a device. Such visible technologies may include technologies for converting images (in any spectrum range) into humanly perceptible images, converting content of visible images into a given user's perceptible content, such as by character recognition, translation, playback rate adjustment, playback frequency adjustment, and otherwise. A visual I/O interface may be configured to use one or more display devices, such as an internal display and/or external display for a given device with the display(s) being configured to present visible signals to a user. A visual I/O interface may be configured to use one or more image capture devices to capture content. Non-limiting examples of image capture devices include lenses, cameras, digital image capture and processing software, and the like. Accordingly, it is to be appreciated that any existing or future arising visual I/O interfaces, devices, systems and/or components may be utilized by and/or in conjunction with a device to facilitate the capture, communication and/or presentation of visible signals to a user.

### Bet Processing System 100

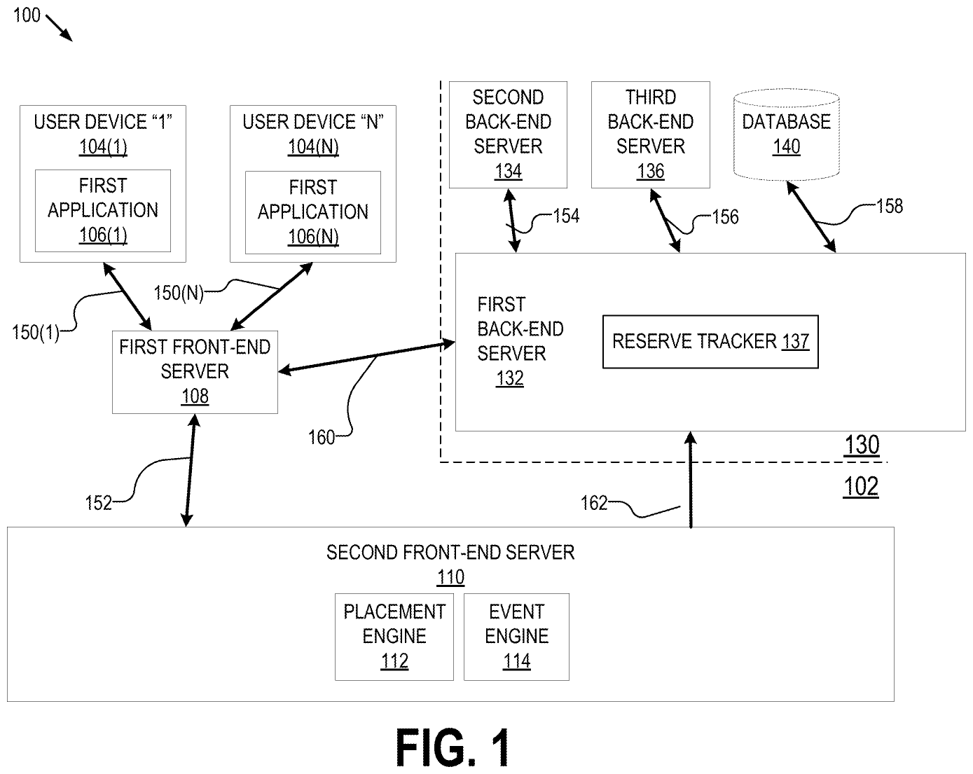

As shown in FIG. 1 and for at least one implementation of the present disclosure, a bet processing system 100, may include a front-end system (FES) 102 and a back-end system (BES) 130. The system 100 may be configured to facilitate operations executed by the FES 102 occur independently of one or more operations executed by the BES 130. For a non-limiting example, FES 102 operations may include wagering operations (e.g., event content validation, odds validation, user limits, and the like) while the BES 130 operations may include financial operations.

The system 100 may be configured to communicate on-line gaming messages (herein, also referred to as being a “message”) by the FES 102 to the BES 130 using at least one data stream. As described below, the FES 102 publishes the one or more on-line gaming messages onto a message data stream, and notifies the BES 130 of such publication. The BES 130 may then retrieve, process, and/or reply to a given on-line gaming message on an as-received, as-needed, independent, or another basis. The on-line gaming messages may be deleted from the message data stream based upon an elapse of time, upon retrieval by the BES 130, upon user prompt, or otherwise.

The FES 102 may include one or more user devices 104, such as a first user device 104(1) and an Nth user device 104(N), a first front-end server (1FES) 108, and a second front-end server (2FES) 110. The BES 130 may include a first-back end server (1BES) 132, a second back-end server (2BES) 134, a third back-end server (3BES) 136, and a database 140.

The various system elements may be coupled using one or more couplings. For at least one implementation, the one or more user devices 104 may be coupled, by respective first couplings 150 (as shown, couplings 150(1) and 150(N)) to the 1FESs 108. The 1FES 108 may be coupled to the 2FES 110 by a second coupling 152. The 1BES 132 and 2BES 134 may be coupled by a third coupling 154. The 1BES 132 and 3BES 136 may be coupled by a fourth coupling 156. The 1BES 132 and database 140 may be coupled by a fifth coupling 158. Other couplings may be used for other implementations. The FES 102 and BES 130 components may be coupled by a sixth coupling 160 coupling the 1FES 108 with the 1BES 132, and a seventh coupling 162, coupling the 2FES 110 with the 1BES 132.

### User Device 104

For at least one implementation, the system 100 may include one or more user devices 104. A user device 104 may include one or more device components including, but not limited to, a processor, a data store, a user interface, a communications interface, a power supply, a security component, and other components. The one or more components may be provided with the device or elsewhere, e.g., a remote data store accessible to the device by one or more couplings may be used.

The user device 104 may be configured to execute a first application 106. For at least one implementation, the first application 106 may be an online gaming application which facilitates a user's review, selection and input of one or more on-line gaming bets for one or more events, information regarding the status and final resolution of the events or elements thereof, and settlement of bets placed relative to such events and/or elements thereof.

For a non-limiting example, an event may be a given currently occurring or future occurring NFL™ game, e.g., the New England Patriots vs the Kansas City Chiefs. A betting option for the event may be a final score, a winner, a loser, or the like. An element of the event may be a performance metric for one or more players (e.g., a quarterback passing for over three hundred (300) yards). Any event and/or element(s) thereof may be a subject of one or more on-line gaming bets. As the event progresses, the first application 106 for the given user may provide updates on existing bets, new betting options, odds adjustments, and the like with respect to the event and/or elements thereof. When the event or element thereof concludes, the first application 106 may provide the given user with updates on winnings/losses, or other information pertaining to the event or element thereof. The first application 106 may be configured to provide, for presentation to a user, any information relevant to a given bet, betting event, element thereof, settlement of the bet, or the like.

### Server

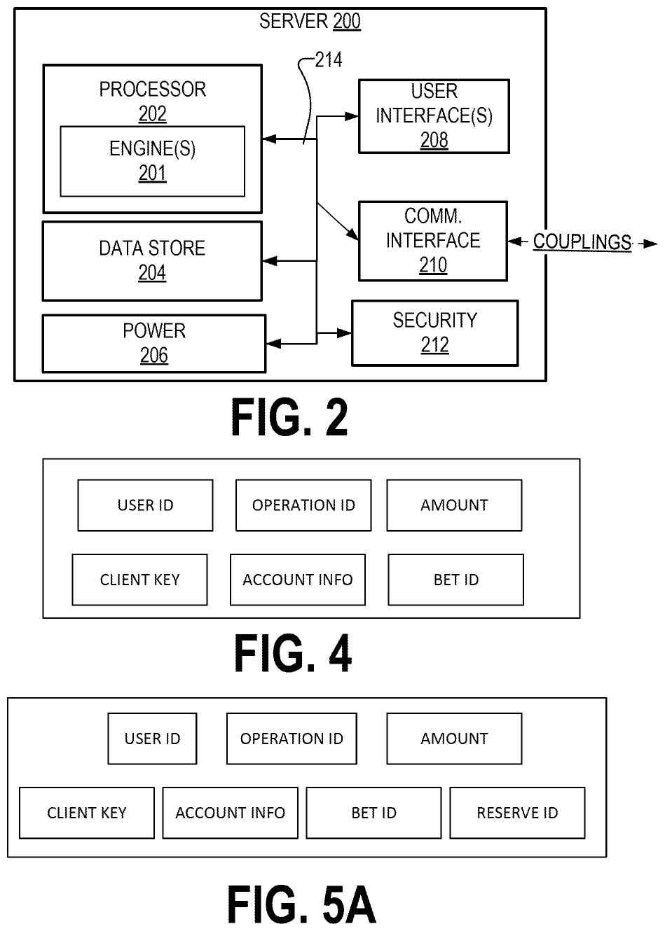

As shown in FIG. 2, a server 200 may include a processor 202 which executes non-transient computer instructions stored in the data store 204 for executing applications, instantiating one more computer engines 203, and performing other device related operations. The computer engines 201 instruct the server and/or other system 100 components to perform various operations which facilitate (among other operations) processing, communication, storage and the like of bet placement messages, settlement messages and other messages between system 100 components, such as between the FES 102 and the BES 130. For at least one implementation, one or more computer engines 201 may be utilized to facilitate communication of messages between the FES 102 and the BES 130. Communication of data between a server 200 and another system 100 component may utilize a communications interface 210 that respectively couples the given server with the other system component(s). The server 200 may further include one or more user interfaces 208, power supply 206, security component 212, and other commonly utilized components for one or more computers and/or computer servers. The server components may be communicatively coupled, by a bus 214.

### 1FES 108

For at least one implementation, the system 100 may include a 1FES 108. The 1FES 108 may be implemented as a server 200, with a non-limiting example of a server being shown in FIG. 2. The 1FES 108 is also referred to herein as a “wager server.” The wager server includes a wager server processor and a wager data store non-transiently storing wager computer instructions.

Any number of 1FESs 108 may be used for a given implementation of the present disclosure with one 1FES 108 being shown in FIG. 1 for purposes of clarity of this description. For at least one implementation, the 1FES 108 may be a proxy server, a load-balancing server, a web server, or the like. The 1FES 108 may be a wager server that is configured to present one or more on-line gaming betting options to a first application 106 executing on a user device 104, receive one or more BPMs from the user device 104, and provide data regarding updates to betting events or elements thereof, a settlement of a previously placed and/or on-going bets, and the like. For at least one implementation and as viewed from the perspective of a user device 104, communications between the user device 104 (and the first application 106) are with the 1FES 108, with other communications and data processing operations for the system 100 occurring by the 2FES 110 and BES 130 elements.

### 2FES 110

For at least one implementation, the system 100 may include a 2FES 110. The 2FES 110 may be a server 200 and may include at least one or more of the components shown in FIG. 2. The 2FES 110 is also referred to herein as a “gaming server.” The gaming server includes a gaming server processor and a gaming data store non-transiently storing gaming computer instructions.

One or more of the components and/or features and functions facilitated by the 1FES 108 and the 2FES 110 may be logically and/or physically separate, combined, virtualized, distributed, or otherwise arranged for a given implementation of the present disclosure. For at least one implementation, the wager server and the gaming server may be combined and provided by a “front-end server” and one or more of the wager data store and the gaming data store may be provided, separately and/or in combination, by a “front-end data store.”

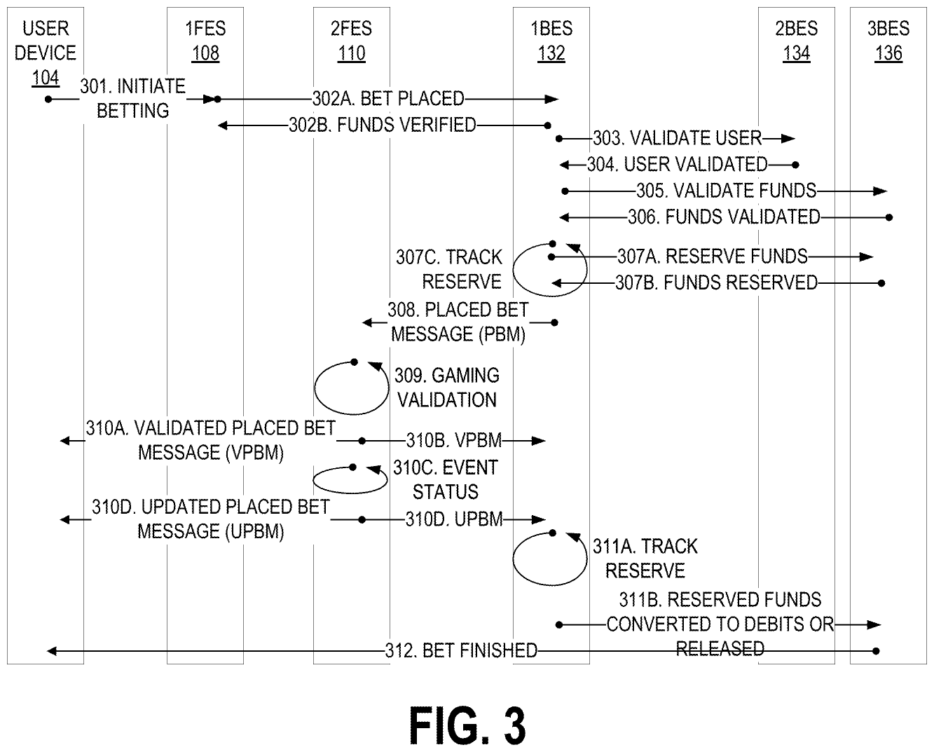

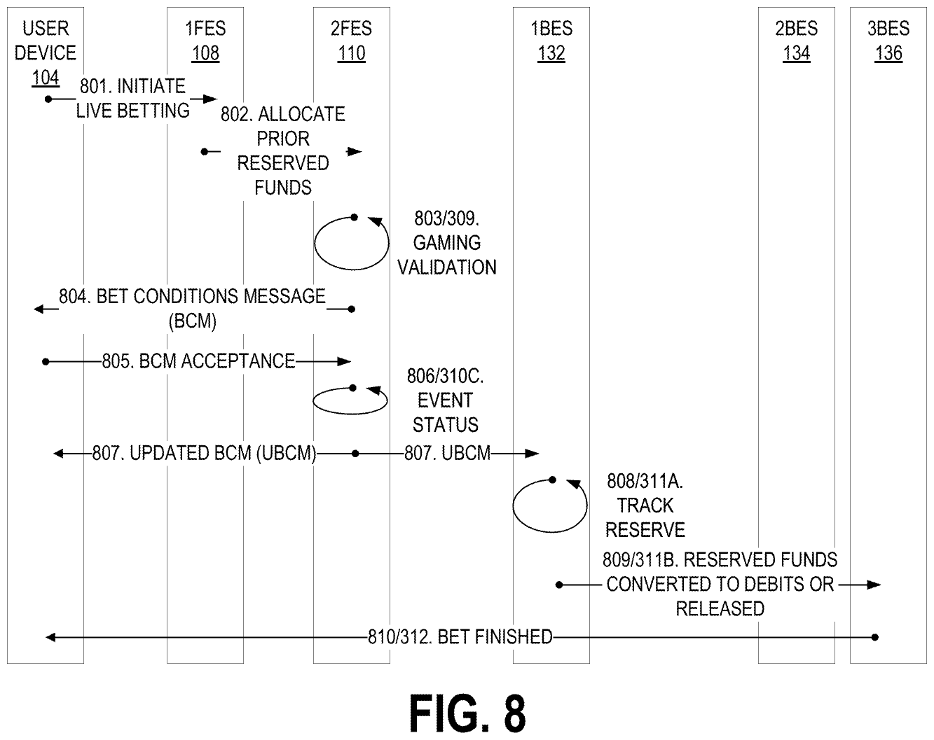

For at least one implementation, the 2FES 110 may be configured to manage aspects of event identification, odds generation, bet placement, bet settlement, settlement message generation, message communication, and the like. For at least one non-limiting example, the 2FES 110 may be configured to execute one or more computer engines with non-limiting examples including: a placement engine 112 which may be configured to receive and process bet placements from one or more users; an event engine 114, which may be configured to track the status of events and elements thereof, adjust odds, and provide data regarding event/element updates and the like. Operations performed by the placement engine 112 and event engine 114 are described herein with reference to FIGS. 3 and 8.

### 1BES 132

For at least one implementation, the system 100 may include a 1BES 132. The 1FES 132 may be a server 200 (as described above and as shown in FIG. 2). Herein, the 1BES is also referred to as a “bet processing server.” The bet processing server includes a bet processing server processor and a bet processing data store non-transiently storing bet processing computer instructions.

The 1BES 132 may be configured to execute one or more non-transient computer instructions which instantiate a reserve tracker engine 131 (as described below with reference to FIGS. 3 and 8).

### 2BES 134

For at least one implementation, the system 100 may include a 2BES 134. The 2BES 134 may be a server (as described above and as shown in FIG. 2). The 2BES 134 may be configured to execute non-transient computer instructions which facilitate user verification and related functions. The 2BES is also referred to herein as a “user verification server.” The user verification server includes a user verification server processor and a user verification data store non-transiently storing user verification computer instructions.

User verification may include operations including, but not limited to, receiving user information, such as name, address, age, citizenship, residency, banking information, and the like. User verification may further include verifying whether a given user is eligible or otherwise permitted to place a given bet, whether the given user has funds and/or access to financial capital to cover the given bet, and the like.

### 3BES 136

For at least one implementation, the system 100 may include a 3BES 136. The 3BES 136 may be a server (as described above and as shown in FIG. 2). The 3BES 136 may be configured to execute non-transient computer instructions which facilitate account management and other accounting related features and functions. The 3BES is also referred to herein as an “accounting server.” The accounting server includes an accounting server processor and an accounting data store non-transiently storing accounting computer instructions.

Non-limiting examples of account management operations may include debiting accounts based upon placed bets, placing reserves on account balances in view of unresolved bets, crediting accounts based on settled bets, advancing lines of credit to an account owner, and otherwise.

To facilitate on-line gaming system communications, for at least one implementation, the 1BES 132 may be configured to utilize HTTP and similar protocols for bet placement, reserve placement and other communications. For at least one implementation, one or more features, functions and operations performed by the 1BES, 2BES and 3BES may be combined and provided by a “back-end server” and one or more of the bet processing data store, verification data store, and accounting data store may be provided, separately and/or in combination, by a “back-end data store.”

### Database 140

The Database 140 may be configured as a data store which stores on-line gaming messages, including reserve messages, settlement messages, account data, and other data. The Database 140 may be used to store data used to process independent bet placements (as described with reference to FIG. 3) and live bet placements (as described with reference to FIGS. 3 and 8). The database 140 may be accessible by one or more of the system 100 components via the Cloud or other couplings.

### Independent Bet Processing Flow

As shown in FIG. 3 and for at least one implementation, independent bet processing may include communication of multiple messages between FES 102 components, messages between FES 102 and BES 130 components, and messages between BES 130 components. In accordance with at least one implementation, communication of message between FES 102 and BES 130 components are minimized to those necessary to place and settle bets, while other messages pertaining to the processing of a bet in view of event activities, as provided by the FES 102 occurring independently of the validation and settlement of bets by the BES 130. For a least one implementation, an independent bet processing flow may include one or operations, which may include one or more message communications, as follows.

It is to be appreciated that a given bet may undergo “user validations” (e.g., validations that a user is whom they purport to be and authorized to engage in the given bet), “financial validations” (e.g., validations that a user's account has sufficient funds to cover a given bet) and “gaming validations” (e.g., validations verifying that given bet is valid in view of the then arising odds, wagering limits, and the like). For at least one implementation, user validations and financial validations may occur using a BES 130 server and gaming validations may occur using a BES 130 server.

Operation 301. User Device to 1FES: For at least one implementation, a user device 104 initiates betting on a given event or activity by communicating a bet message to the 1FES 108. As shown by Operation 301, a bet message may identify one or more of the data fields shown in FIG. 4 and for at least one implementation, a bet message may include data fields, in any given order and for any given length, for one or more of: a user identifier (user ID), an operation identifier (Operation ID), an amount, a client key (used for cryptological purposes), user account information, and a bet identifier (Bet ID). These and/or other data fields may be used in another implementation.

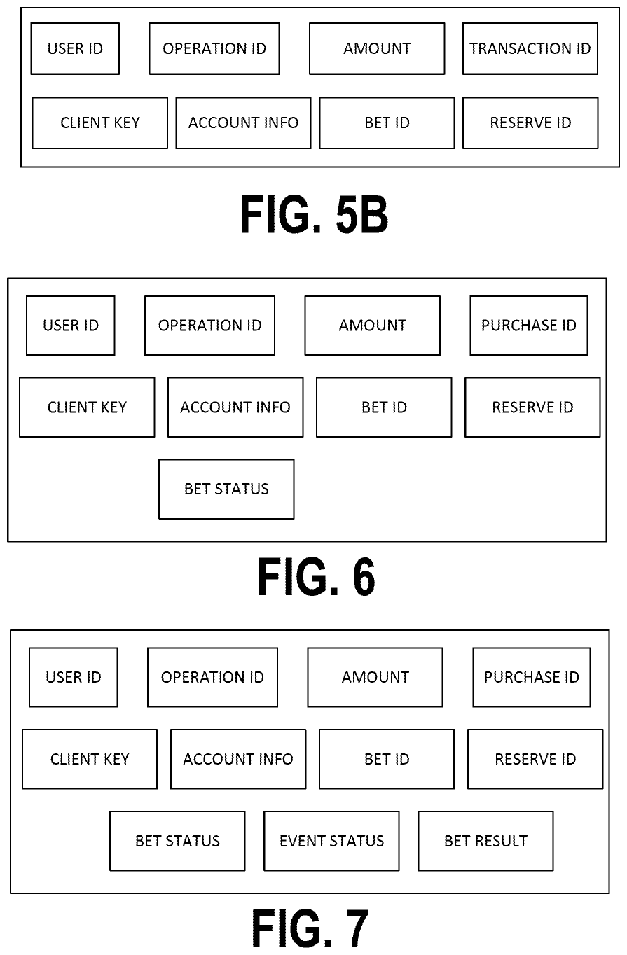

Operations 302A-302B. 1FES to 1BES: As per Operation 302A, the 1FES 108 communicates the bet message to the BES 130. Upon communicating the bet message to the BES 130, from the perspective of the user the “bet” is “placed”—subject to user validations, financial validations, and gaming validations. Upon receiving the bet message, the 1BES 132 associates a “Bet Reserve ID” (BRID) with the bet message of FIG. 4 (herein, a “BM”)—as shown in FIG. 5A (for example, by appending the BRID to the BM). As shown by Operation 702B, the BRID is communicated to the 1FES 108 in a return message.

Operation 303. 1BES to 2BES: As per Operation 303, the 1BES 132 communicates user data, such as the user ID and client key, to the 2BES 134 for user validation of the user by the 2BES 134. For at least one implementation, “user validation” may be a form of “financial validation” performed by the BES 130. For other implementations, “user validation” may be a form of “gaming validation” performed by the FES 102. For another implementation, user validation may occur by the FES 102 and the BES 130. User validation may occur using any known or later arising user verification technologies, and/or combinations thereof including, but not limited to, user ID and password, private key of a previously established private-public key exchange, two-factor authentication, bio-metric identification, or otherwise. One or more user validation techniques may be used for a given user validation operation.

Operation 304. 2BES to 1BES: As per Operation 304 and as based on results of the one or more user validation techniques utilized per Operation 703, the 2BES 134 may generate a “User Validated”, “User Not Validated”, “More Info Needed” message, or the like and communicate such message back to the 1BES 130. For at least one implementation, Operations 303 and 304 may occur at any time, may be repeatedly, and/or may occur repeatedly, during a bet in view of changes to one or more terms of a bet, such as amount wagered, odds, limits, or the like, changes in user accounts, or otherwise. For at least one implementation, when user validation fails for any reason the bet is automatically cancelled. For another implementation, a failed user validation may result in one or messages being communicated to the user for additional verification of the user. Such additional verifications may include use of biometric identifiers, multi-factor authentication, or the like.

Operation 305. 1BES to 3BES: As per Operation 305, the 1BES 132 queries the 3BES for “financial validation”—a verification that sufficient funds exist in one or more accounts associated with the given user to cover the bet. Non-limiting examples of such data communicated may include the user ID, amount ID, purchase ID, user account information, bet ID, reserve ID, and the like. The financial validation may occur once, repeatedly, repetitiously or otherwise with respect to a given bet. When sufficient funds are not verified, the bet may fail, be modified to cover wagering of an amount provided by the funds in the associated accounts, or otherwise. It is to be appreciated that for at least one implementation, a modification of an amount wagered may occur upon a user's prior or contemporaneous granting of permission for a bet to be modified.

Operation 306. 3BES to 1BES: As per Operation 306, when the funds associated with the bet are validated to exist in the account(s) associated with the user, a user funds confirmation message is communicated by the 3BES 136 to the 1BES 132.

Operations 307A, 307B, and 307C. Reserve Tracking: The 1BES 132 may further facilitate financial validation by establishing and tracking reserves for a given bet. A reserve is essentially a debiting of an account (or a hold thereon) which ensures sufficient funds will be available to pay a user's obligations regarding a given bet. As per Operation 307A, the 1BES 132 establishes, using for example a reserve process tracker 137, a reserve tracker for the bet. The reserve ID may be used for tracking reserves generated for a given bet. For at least one implementation, the reserve tracker instructs the 3BES 136 to debit or otherwise place a hold on the account(s) identified in the message communicated per Operation 706. As shown by Operations 707A and 707B, messages may be communicated between the 1BES 132 and the 3BES 136 which reserve the funds in the one or more validated accounts. As shown in FIG. 5B, a confirmation message may add a “transaction ID” or similar identifier for a debit action used to reserve funds for the bet. It is to be appreciated that for at least one implementation, a block-chain or similar form of immutable transaction ledger may be used for communication message validation, tracking and the like.

As per Operation 307C, the reserve tracker tracks a status of funds debited in user accounts and associated with a given bet. It is to be appreciated that some bets, with respect to which a reserve has been established, may ultimately end up not passing gaming validation. For example, communications delays or other processing delays, may result in a funds being reserved for a bet during financial validation, but gaming validation failing and the bet ultimately not being placed. To minimize delays occurring between bets passing financial validations (and having a reserve established) but not passing gaming validations, the reserve tracker may utilize a pre-determined period in which a confirmation must be received from that 2FES 110 that a given bet has passed gaming validation. For at least one implementation and with respect to a given bet, the reserve tracker must receive a gaming validation within four-hundred and fifty milliseconds (450 ms) of a financial validation for the given bet. A gaming validation may not be timely communicated for one or more reasons, with non-limiting examples including the 2FES 110 rejecting a PBM (as described below),

For at least one implementation, when a gaming validation is not timely received, the bet may be cancelled by the 1BES 132 and any reserved funds are released by the 3BES 136. Corresponding messages are communicated to the 1FES 108 and the 2FES 110 notifying them that the bet has been cancelled. It is to be appreciated that cancellation of a given bet may affect odds associated with one or more other bets, including other bets by the user or other users, accordingly the system 100 may be configured to minimize delays between financial validations and gaming validations by reducing the communications and processing overhead of existing systems.

Operation 308, 1BES to 2FES: As per Operation 308 and upon a reserve being established for the given bet, the 1BES 132 communicates a “placed bet message” (PBM) to the 2FES 110. The PBM identifies to the 2FES 110 that the user has been user validated and financial validated, a reserve has been established for the bet amount, the user's account debited, and the like. For at least one implementation, the PBM may include data included in one or more of the fields shown in FIGS. 5A and 5B.

Operation 309, Gaming Validation: As per Operation 309, in response to receiving the PBM, the 2FES 110 performs gaming validation. Gaming validation may include verifying that one or more conditions associated with the given bet are still valid such as verifying and/or modifying odds, incentives, or other characteristics of the given bet, verifying the event activity has not occurred, and the like. A result of gaming validation may include one of “confirmed,” “modified” or “cancelled. A confirmed result may indicate that the bet, as placed by the user per Operation 301 is valid and pending event (and/or event activity) results. A modified result may indicate that one or more terms of a bet have changed, with non-limiting examples including odds, bet limits, or the like. For modified result, acceptance of the as modified bet may or may not be needed, as determined for a given bet and/or implementation of the present disclosure. For a cancelled bet, the bet as placed will not be processed.

Operation 310A—310B, Bet Status: As per Operation 310A, upon gaming validation being completed, the 2FES 110 communicates a validated placed bet message (VPBM) to the user device 104 (via the 1FES 108) and, per Operation 310B, to the 1BES 132. For confirmed bets, the VPBM indicates a valid bet will occur unless timely cancelled by the user. As used herein, a bet is “timely cancelled” when a bet recission message is received by the 1FES prior to a final bet cancellation time. The final bet cancellation time may vary between different betting options. As shown FIG. 6, a VPBM may include a bet status data, indicating whether the bet is confirmed, modified or cancelled, and event status data, indicating a current status of an event and/or an event activity with respect to which the bet has been placed.

Operation 310C—310D, Event Status: As per Operation 310C, 2FES 110 monitors the event (or event activity) for completion thereof. While a bet is validated (as per a VPBM) and pending, the 2FES 110 may periodically, or upon request, send an updated placed bet message (UPBM) indicating the current status of the bet. A non-limiting example of a UPBM is shown in FIG. 7. Non-limiting examples of a current status of a bet include completed, cancelled, revised, awarded in part, or the like. The UPBM may be sent to one or more of the user device 104 (via the 1FES 108) and 1BES 132 once, repeatedly, periodically, intermittently, or otherwise. For at least one implementation, the UPBM is sent once upon gaming validation being completed, and once every one-thousand milliseconds (1,000 ms) until a given period has elapsed after the event (or event activity) has been completed, cancelled, or otherwise.

Operation 311A and 311B. Track Reserve: As per Operation 311A, the process may include the reserve tracker 132 monitoring the status of the reserves identified in a PBM. The reserve tracker may monitor the status based on bet status data and/or event status data communicated in a VPBM or UPBM received from 2FES 110. For at least one implementation and with respect to which a given bet has passed gaming validation and the bet is completed, as per Operation 311B, the 1BES 132 may update the user's accounts by debiting, in whole or in part, the reserved amount and/or releasing any remaining reserved amounts, when the debiting is not for the entirety of the reserved funds, as the case may be.

For at least one implementation, the reserve tracker may implement a hanging reserve process which monitors placed bets, as reflected in BPMs, VPBMs and UPBMs for indications of the event (or event activity) terminating (by being completed, cancelled, revised, or otherwise). The reserve processor may monitor placed bets by one or more operations including verifying a BPM is generated for a given BRID, verifying a VPBM is received for a BPM, verifying a UPBM is timely received for a VPBM, verifying a “debit verification”—a debiting of the user's account, by the 3BES 136 and upon receiving a UPBM indicting the bet is finished, has occurred within a given period following completion of the bet, and the like. It is to be appreciated that a debit verification may not be successfully completed by the reserve tracker 127 for one or more reasons including messages from the 3BES 136 not being timely received by the 1BES 132, the 3BES 136 rejecting a request to debit the account(s).

Operation 312. Bet Finished: As per Operation 312, a bet is finished when reserved funds are properly committed (debited) or released. When the bet is finished, the 1BES 132 communicates a bet finished message to the user device 104 via one or more of the 1FES 108 and the 2FES 110.

It is to be appreciated that the process flow of the present disclosure differs from existing process flows used in at least one prior art system, where a bet was communicated by the 1FES 108 to the 2FES 110 substantially simultaneously with the bet being communicated by the 1FES 108 to the 1BES 132. Per such prior processes, the 2FES 110, which is responsible for processing the bet in view of event activities, then appended a “reserve ID” (RID) to the bet and tracked the RID status. Upon a bet being completed, the 2FES 110 then communicated a “confirmation reserve ID” (CRID) message to the 1BES 132. The RID and the CRID were communicated asynchronously with respect to the bet. The CRID, when sent, would instruct the 1BES 132 and 3BES 136 to either debit, commit, or cancel any reserved funds. Thus, with the prior art approach, processing of reserved funds would require processing by both the 2FES 110 and the 1BES 132 and 3BES 136 with asynchronous messages flowing therebetween creating dependencies between FES 102 and BES 130 processes. Such asynchronous message flows often impeded timely processing of bets and settlements thereof. Accordingly, it is to be appreciated that the message flow of the present disclosure simplifies bet processing and messaging, and thereby reduces network and processor loads, by transferring reserve processing from the FES 102 to the BES 130, while continuing to provide user validation and financial validation by the BES 130 and gaming validation by the FES 102.

### Live Bet Processing

As shown in FIG. 8 and for at least one implementation, live bet processing may include communication of multiple messages between FES 102 components so that bets are timely placed while event or event activities are actively monitored. To eliminate communication and/or data processing delays that may occur for user validation and reserve establishment used with independent bet processing (as discussed above with regards to the implementation of FIG. 3), for live bet processing it is assume that user validation and financial validation has already occurred. Further, for live bet processing a reserve has already been established and thus reserves for each bet need not be placed before the event or event activity occurs.

As per Operation 801, live betting may be initiated by a user device 104 communicating a live bet message (“LBM”) to the 1FES 108.

As per Operation 802, the 1FES 108 may allocate previously reserved funds (as may have been allocated per Operations 305-307) to the LBM. The allocated funds are communicated to the 2FED 110 for use in performing gaming validation.

As per Operation 803, gaming validation may occur per Operation 309.

As per Operation 804, the 2FES 110 may communicate a bet conditions message (BCM) to the user device 104 (e.g., via the 1FES 102). The BCM may contain some or all of the data fields provided in a VPBM with the reserve Id designating a common reserve Id to be used for one or more live bets. That is, unlike an independent bet where a reserve ID for each bet may be established, along with a reserve, for a live bet, a common reserve ID for a common pool of reserved funds may be utilized.

As per Operation 805, the user device 104 may communicate a BCM acceptance message to the 2FES 110 at which instance the bet is deemed “placed.”

As per Operation 806, the 2FES 110 performs event status monitoring. For at least one implementation, event status monitoring for live bets and independent bets may occur commonly, as designated by Operation 310C of FIG. 3. For an operation, live and independent bet status monitoring may occur separately. For an implementation, live event status monitoring may be given priority over independent bet status monitoring.

As per Operation 807, the 2FES 110 may periodically and at the completion of an event (or event activity) communicate an updated bet conditions message (UBCM). For an implementation, the UBCM may contain data fields common to a UPBM. For an implementation, the UBCM may contain data fields indicating a priority of a BCM or otherwise. Such priority data may be utilized by the 1BES 132 in determining a sequence in which UBCMs and UPBMs undergo reserve processing.

As per Operation 808, the 1BES 132 may track reserves, as per Operation 311A. Here, the tracking of reserves may occur based upon UBCMs, which indicate that the common reserve fund is to be committed or released in part, as provided for by a given BCM (and as reflected in the corresponding UBCM).

As per Operation 809, the 1BES 132 instructs the 3BES 136 to convert some (or all) of the reserved funds into debits, while reducing the available balance of any reserved funds for live betting. For those UBCMs where the user has a winning bet, it is to be appreciated that no action may be required by the 3BES 136 with regards to the reserve funds and the reserve funds pool itself may remain unchanged.

As per Operation 810, when a given live bet is finished, a bet finished message may be communicated to the user device, via the 2FES 110 and/or 1FES 102. When all live betting and independent betting is finished, a bet finished message may be communicated to the user device 104, for example, as per Operation 312.

As shown in FIG. 4 and for at least one implementation, a BPM may include data fields, in any given order and for any given length, for one or more of a: a user identifier (user ID), an operation ID, an amount field, a client key, account information, betting ID, and other data relating to a given settlement of a given bet or collection of bets.

As shown in FIGS. 5A and 5B and for at least one implementation, in addition to the fields shown in FIG. 4, a PBM may include a reserve ID data field.

As shown in FIG. 6 and for at least one implementation, in addition to the fields shown in FIG. 5A, a VPBM may include a bet status data field.

As shown in FIG. 7 and for at least one implementation, in addition to the fields shown in FIG. 5A, a UPBM may include an event status and, when a bet is completed, a bet result field.

Although various implementations have been described above with a degree of particularity, or with reference to one or more individual implementations, those skilled in the art could make numerous alterations to the disclosed implementations without departing from the spirit or scope of the present disclosure. The use of the terms “approximately” or “substantially” means that a value of an element has a parameter that is expected to be close to a stated value or position. As is well known in the art, there may be minor variations that prevent the values from being as stated. Accordingly, anticipated variances, such as 10% differences, are reasonable variances that a person having ordinary skill in the art would expect and know are acceptable relative to a stated or ideal goal for one or more implementations of the present disclosure. It is also to be appreciated that the terms “top” and “bottom,” “left” and “right,” “up” or “down,” “first,” “second,” “next,” “last,” “before,” “after,” and other similar terms are used for description and ease of reference purposes and are not intended to be limiting to any orientation or configuration of any elements or sequences of operations for the various implementations of the present disclosure. Further, the terms “coupled,” “connected” or otherwise are not intended to limit such interactions and communication of signals between two or more devices, systems, components or otherwise to direct interactions; indirect couplings and connections may also occur. Further, the terms “and” and “or” are not intended to be used in a limiting or expansive nature and cover any possible range of combinations of elements and operations of an implementation of the present disclosure. Other implementations are therefore contemplated. It is intended that matter contained in the above description and shown in the accompanying drawings be interpreted as illustrative of implementations and not limiting. Changes in detail or structure may be made without departing from the basic elements of the present disclosure as described in the following claims.

What is claimed is:

1. A system comprising:
a front-end system (“FES”); and
wherein the FES includes at least one FES server configured to execute computer instructions which configure the FES to perform first front-end operations comprising:
communicating a betting option for an event to a user device;
wherein the user device is associated with a user;
receiving a bet, from the user device, for the event;
monitoring the event; and
validating the bet; and
a back-end system (“BES”) coupled to the FES;
wherein the BES includes at least one BES server configured to execute second computer instructions which configure the BES to perform first back-end operations comprising:
receiving the bet from the FES;
verifying the user;
validating user funds; and
designating, from the user funds, reserved funds for covering the bet; and
wherein the front-end operations are performed independently of the back-end operations.

2. The system of claim 1,
wherein the at least one FES server further comprises:
a wager server, coupled to the user device and the BES, comprising:
a wager server processor; and
a wager data store, coupled to wager server processor, non-transiently storing wager computer instructions; and
a gaming server, coupled to the wager server and the BES, comprising:
a gaming server processor; and
a gaming data store, coupled to the gaming server processor, non-transiently storing gaming computer instructions.

3. The system of claim 2,
wherein the wager computer instructions, when executed by the wager server processor, instruct the FES to:
perform the first front-end operations of:
communicating, in a second message, the betting option for the event to the user device associated with the user; and
receiving the bet, from the user device, for the event; and
further perform second front-end operations including:
receiving the betting option from the gaming server;
receiving the bet in a bet placement message (BPM) sent by the user device;
communicating the BPM to the gaming server; and
communicating the BPM to the BES.

4. The system of claim 2,
wherein the gaming computer instructions, when executed by the gaming server processor, instruct the FES to:
perform the first front-end operations of:
monitoring the event; and
validating the bet; and
further perform second front-end operations including:
identifying the event;
generating odds for the event;
generating the betting option;
communicating the betting option in a first message to the wager server;
wherein the first message identifies the event and the odds for the event;
receiving the BPM from the wager server;
receiving a placed bet message (PBM) from the BES;
validating the event;
monitoring the event;
when the event ends, generating an updated placed bet message (UPBM);
communicating the UPBM to the wager server; and
communicating the UPBM to the BES.

5. The system of claim 4,
wherein the PBM include a bet reserve identifier (BRID) associated with the BPM.

6. The system of claim 3,
wherein the gaming computer instructions, when executed by the gaming server processor, further instruct the FES to:
perform the first front-end operations of:
monitoring the event; and
validating the bet; and
further perform third front-end operations including:
identifying the event;
generating odds for the event;
generating the betting option;
communicating the betting option in a first message to the wager server;
wherein the first message identifies the event and the odds for the event;
receiving the BPM from the wager server;
receiving a placed bet message (PBM) from the BES;
validating the event;
monitoring the event;
when the event ends, generating an updated placed bet message (UPBM);
communicating the UPBM to the wager server; and
communicating the UPBM to the BES.

7. The system of claim 6,
wherein the event is an on-line gaming event.

8. The system of claim 7,
wherein the gaming computer instructions further instruct the FES to periodically generate the UPBM during the event; and
wherein the UPBM includes an event status.

9. The system of claim 1,
wherein the at least one BES server further comprises:
a bet processing server, coupled to the FES, comprising:
a bet processing server processor; and
a bet processing data store, coupled to bet processing server processor, non-transiently storing bet processing computer instructions;
a user verification server, coupled to the bet processing server, comprising:
a user verification server processor; and
a user verification data store, coupled to the user verification server processor, non-transiently storing user verification computer instructions; and
an accounting server, coupled to the processing server, comprising:
an accounting server processor; and
an accounting data store, coupled to the accounting server processor, non-transiently storing accounting computer instructions.

10. The system of claim 9,
wherein the bet processing computer instructions, when executed by the bet processing server processor, instruct the BES to:
perform the first back-end operations of:
receiving the bet from the FES;
designating, from the user funds, reserved funds for covering the bet;
further perform second back-end operations including:
receiving, from the wager server, a bet placement message (BPM);
further designating the reserved funds, by further performing operations including:
sending, based on data provided in the BPM, a funds validation request to the accounting server; and
receiving, from the accounting server in response to the funds validation request, a user funds confirmation message when sufficient user funds exist in at least one account associated with the user for the reserved funds; and
communicating first user data provided in the BPM to the user verification server;
communicating second user data provided in the BPM to the accounting server;
associating a best reserve identifier (BRID) with the BPM;
communicating a placed bet message (PBM) to the gaming server; and
upon, receiving an updated placed bet message (UPBM) from the gaming server indicating that the event has completed, performing debit verification; and
releasing, after debit verification has completed, any remaining reserved funds back into the user account.

11. The system of claim 9,
wherein the user verification computer instructions, when executed by the user verification server processor, instruct the BES to:
perform the first back-end operation of verifying the user based on first user data provided in a BPM received from the bet processing server.

12. The system of claim 9,
wherein the accounting computer instructions, when executed by the accounting server processor, instruct the BES to:
perform the first back-end operation of validating user funds based on second user data provided in a BPM received from the bet processing server.

13. The system of claim 10,
wherein the user verification computer instructions, when executed by the user verification server processor, instruct the BES to:
perform the first back-end operation of verifying the user based on first user data provided in a BPM received from the bet processing server; and
wherein the accounting computer instructions, when executed by the accounting server processor, instruct the BES to:
perform the first back-end operation of validating user funds based on second user data provided in a BPM received from the bet processing server.

14. The system of claim 13,
wherein the first user data includes a user identifier, an operation identifier, an amount, a client key, user account information, and a bet identifier.

15. The system of claim 14,
wherein the second user data includes the user identifier, the amount identifier, a purchase identifier, the user account information, the bet identifier and the BRID.

16. A system comprising:
a user device associated with a user;
a front-end system (FES) coupled to the user device; and
a back-end system (BES) coupled to the FES;
wherein the FES comprises:
a wager server comprising:
a wager server processor; and
a wager data store, coupled to wager server processor, non-transiently storing wager computer instructions;
a gaming server comprising:
a gaming server processor; and
a gaming data store, coupled to the gaming server processor, non-transiently storing gaming computer instructions;
wherein the wager computer instructions, when executed by the wager server processor, instruct the FES to perform first front-end operations including:
receiving a betting option for an event from a gaming server;
communicating the betting option to the user device;
receiving a bet placement message (BPM) from the user device;
wherein the BPM identifies a bet, by the user, for the event;
communicating the BPM to the gaming server; and
communicating the BPM to the BES;
wherein the gaming computer instructions, when executed by the gaming server processor, instruct the FES to perform second front-end operations including:
identifying the event;
generating odds for the event;
generating the betting option;
communicating the betting option to the wager server;
wherein the betting option identifies the event and the odds for the event;
receiving the BPM from the wager server;
validating the bet;
receiving a placed bet message (PBM) from the BES;
validating the event;
monitoring the event;
generating an updated placed bet message (UPBM) when the event ends;
communicating the UPBM to the wager server; and
communicating the UPBM to the BES;
wherein the BES comprises:
a bet processing server comprising:
a bet processing server processor; and
a bet processing data store, coupled to bet processing server processor, non-transiently storing bet processing computer instructions;
a user verification server comprising:
a user verification server processor; and
a user verification data store, coupled to the user verification server processor, non-transiently storing user verification computer instructions;
an accounting server comprising:
an accounting server processor; and
an accounting data store, coupled to the accounting server processor, non-transiently storing accounting computer instructions;
wherein the bet processing computer instructions, when executed by the bet processing server processor, instruct the BES to perform first back-end operations including:
receiving, from the wager server, the BPM;
communicating first user data provided in the BPM to the user verification server;
communicating second user data provided in the BPM to the accounting server;
sending a funds validation request to the accounting server;
when sufficient user funds exist in a user account to cover the bet,
receiving, from the accounting server in response to the funds validation request, a user funds confirmation message designating identified user funds;
designating the identified user funds as reserved funds for the bet;
associating a best reserve identifier (BRID) with the BPM;
communicating a placed bet message (PBM) to the gaming server; and
upon, receiving the UPBM from the gaming server indicating that the event has completed, performing debit verification; and
releasing, after debit verification has completed, any remaining reserved funds back to the user account;
wherein the user verification computer instructions, when executed by the user verification server processor, instruct the BES to verify the user based on first user data provided in the BPM;
wherein the accounting computer instructions, when executed by the accounting server processor, instruct the BES to validate user funds based on second user data provided in the BPM.

17. The system of claim 16,
wherein the gaming computer instructions further instruct the FES to periodically generate the UPBM during the event; and
wherein the UPBM includes an event status.

18. The system of claim 16,
wherein the gaming computer instruction, upon validating the event, further instruct the FES to communicate a validated placed bet message (VPBM) to the user device; and
wherein the VPBM indicates that the bet will occur unless timely cancelled by the user.

19. A process, for processing live bets for an event, comprising:
communicating, by a user device, a live bet message to a front-end system (FES) of a bet processing system;
wherein the live bet message identifies, for a bet, a user, an amount, a user account, and an event;
allocating, from previously reserved user funds in the user account, currently reserved funds;
validating the event;
communicating a bet conditions message (BCM) by the FES to the user device;
monitoring the event;
updating the BCM based upon a current event status and generating an updated bet conditions message (UBCM);
communicating at least one UBCM to a back-end system (BES);
tracking, by the BES and in view of the at least one UBCM, a status of the currently reserved funds; and
converting, by the BES, at least a portion of the previously reserved funds into a debit to the user account when the current event status indicates the event is completed; and
communicating, when the event is completed, by the FES and to the user device, a bet finished message indicating whether one or more credits or debits have been applied to the user account in view of the bet and results of the event.

20. The process of claim 19,
wherein the BCM includes a reserve identifier which designates a common reserve identifier to be used by the FES for live betting.
